(19) United States
(12) Patent Application Publication
(10) Pub. No.: US 2022/0357246 A1
(43) Pub. Date: Nov. 10, 2022

(54) COMPOSITION AND METHOD FOR RENDERING BIOLOGICAL MATERIAL

(71) Applicant: JELLOX BIOTECH INC., Hsinchu City (TW)

(72) Inventors: CHIA-JUNG LEE, Zhubei City, Hsinchu County (TW); YU-CHIEH LIN, Zhubei City, Hsinchu County (TW); YEN-YIN LIN, Zhubei City, Hsinchu County (TW)

(21) Appl. No.: 17/623,250

(22) PCT Filed: Aug. 7, 2020
(86) PCT No.: PCT/CN2020/107638

§ 371 Date: Dec. 28, 2021

Related U.S. Application Data
(60) Provisional application No. 62/883,656, filed on Aug. 7, 2019.

(51) Int. Cl. G01N 1/30; G01N 1/34

(52) U.S. Cl. CPC G01N 1/30; G01N 1/34

(57) ABSTRACT

The disclosure provides a clearing composition and a method utilizing the clearing composition for rendering a biological sample transparent. The clearing composition includes a RI matching material, a permeating agent including a surfactant, at least two labeling materials, and a solvent. The sample rendering method includes the steps of: (a) fixing a biological sample with a fixative solution; (b) embedding the biological sample into an embedding material; (c) immersing a biological sample in the clearing composition so the sample is permeated by the cleaning composition; and (d) mounting, by a mounting solution, the permeated biological sample.

### CROSS REFERENCE TO RELATED APPLICATION

The present application claims priority to US Provisional Application Serial No. 62/883,656, filed on Aug. 7, 2019, which are hereby incorporated by reference in their entirety.

### FIELD

This disclosure relates to a composition and a method used in the field of biological tissue analysis, and more particularly, to a composition of an aqueous clearing solution for rendering a biological tissue and making it transparent, and the method of using the composition.

### BACKGROUND

Confocal microscopy provides multiple advantages over conventional wide-field optical microscopy when it comes to biological tissue image capturing and analysis. Exemplary advantages include the ability to control the depth of field, elimination or reduction of background information distant from the focal plane, and the capability to capture a series of optical sections continuously from thick specimens. The foregoing advantages of confocal microscopy are achieved primarily are achieved due to spatial filtering, which eliminates out-of-focus light or glare in specimens whose thickness exceeds the immediate plane of focus. Through confocal microscopy, sub-micron fluorescence biological images can be acquired in a more desired manner.

Under normal circumstances, the thickness of the tissue limits the degree of penetration of light because the mass of the tissue is opaque when not treated. One way of overcoming the foregoing issue is to slice a large/thick tissue into thinner samples so it's suitable for observation by a microscope. The other method is to make the tissue transparent so that light can pass through the mass. In some situations, in order to observe an internal target of a non-transparent tissue by an optical microscope or a confocal microscopy, a pretreatment is needed. One exemplary pretreatment is called a clearing treatment. Essentially, a subject tissue is rendered transparent using a clearing reagent.

US 2014/0087419 A1 Patent Application (hereinafter “the ‘419 Application”) (Atsushi Miyawaki et al., 2012) discloses a method for making a biological material transparent. The ‘419 application mentioned that, in the prior art, an organic solvent is essential as an active component or the like for the clearing treatment. However, the corresponding clearing methods are applicable to fixed samples mainly, but mostly inapplicable to living tissues. Such methods also bear a risk of causing shrinkage of the biological material. To address the foregoing, the ‘419 application taught to use urea to make a biological material transparent. Since urea possesses the characteristic of high bio-affinity, the use of urea or a urea derivative as an active component for clearing treatment may likely solve the above problems.

The method disclosed in the ‘419 Application involves impregnating a tissue sample with two permeation solution respectively. Further, the first permeation solution contains at least one compound of urea or urea derivatives, and the second permeation solution contains at least one compound of urea or urea derivatives and at a concentration higher than the concentration of the compound contained in the first solution.

WO 2011/111876 A1 Patent Application (hereinafter “the ‘876 Application”) (Atsushi Miyawaki et al., 2010) discloses a reagent for making a biological material transparent. More specifically, the reagent contains an active component and at least one compound of urea or urea derivative. According to the ‘876 Application, in the prior art, a solution called the FocusClear™ solution is used to make a tissue sample transparent. However, because the FocusClear™ solution contains dimethyl sulfoxide (DMSO) or the like (e.g., an active component), it's not ideal to be applied on living tissues. As such, the FocusClear™ solution is limited largely to fixed samples. Furthermore, the composition of the FocusClear™ solution is complicated, resulting in a complicated and costly preparation process. Additionally, the FocusClear™ solution causes nervous tissues to shrink and does not sufficiently clear turbidity of nervous tissues at deep areas. In certain other prior arts, the clearing solutions require use of a large amount of organic solvent, which damages almost all fluorescent proteins. The result is that it is difficult to perform a tissue observation using a fluorescent protein.

To solve the foregoing problems, the ‘876 Application discloses a clearing reagent for making a biological material transparent that contains an active component having a higher bio-affinity. Briefly, the clearing reagent of the ‘876 Application includes an active component having at least one compound urea or urea derivatives. However, the method in the ‘876 Application still possesses some flaws of undesired processing time and cost.

### SUMMARY OF THE DISCLOSURE

The present disclosure reveals a clearing composition for rendering a biological material transparent. The clearing composition may come with a kit. The cleaning composition includes a Refractive Index (RI) matching material, a permeating agent including a surfactant, a first labeling material, a second labeling material, and a solvent.

In some embodiments, the pH value of the biological material transparent is about 6.5 to 8.4.

In some embodiments, the RI matching material includes a radiocontrast agent, monosaccharide, oligosaccharide, or any combination thereof.

In some embodiments, the RI matching material includes iodixanol, fructose, sucrose, or any combination thereof.

In some embodiments, the permeating agent includes a detergent.

In some embodiments, the surfactant does not have any ionic material.

In some embodiments, the surfactant includes Triton X-100, Tween-20, Tween-80, Sodium dodecyl sulfate (SDS), n-Dodecyl-β-D-maltoside (DDM), Urea, 3-[(3-Cholamidopropyl) dimethylammonio]-1-propanesulfonate (CHAPS), sodium deoxycholate, or any combination thereof.

In some embodiments, the surfactant is Triton X-100 or Tween 20.

In some embodiments, a critical micelle concentration (CMC) value of the surfactant is about 0.01 to 0.025.

In some embodiments, the solvent includes phosphate buffered saline (PBS), dimethyl sulfoxide (DMSO), glycerol, ddH₂O or any combination thereof.

In some embodiments, the first and second labeling material is an agonist, antagonist, antibody, avidin, dextran, lipid nucleotide or phallotoxin.

In some embodiments, the first labeling dye includes DAPI, Propidium Iodide, SYTO 16, SYTO 40, NucRed or NucGreen.

In some embodiments, the second labeling dye includes a lipophilic tracers fluorescence dye.

In some embodiments, the clearing composition or the kit thereof further includes an anti-freezer, a humectant or a combination thereof.

In some embodiments, a weight/volume percentage concentration of the RI matching material to the clearing composition is in a range of 30-80% (w/v).

In some embodiments, a volume/volume percentage concentration of the permeating agent to the clearing composition is in a range of 0.1-2% (v/v).

In some embodiments, a concentration of the first labeling material to the clearing composition is in a range of 100 ng/ml to 1 mg/ml.

In some embodiments, a concentration of the second labeling material to the clearing composition is in a range of 1 ug/ml to 1 mg/ml.

In some embodiments, the clearing composition or the kit thereof further a third labeling material.

The present disclosure also discloses a method for making a biological material transparent and further labeling the biological material. The method includes the following steps: (a) fixing a specimen with a fixative solution; (b) embedding, by an embedding material, the specimen; (c) immersing a specimen with the aforementioned clearing composition and allow the clearing composition to permeate the specimen; and (d) mounting, by a mounting solution, the permeated specimen on a slide.

In some embodiments, the fixation reagent includes formaldehyde, phosphate buffered formalin, formal calcium, formal saline, zinc formalin, Zenker's fixative, Helly's fixative, B-5 fixative, Bouin's solution, Hollande's, Gendre's solution, Clarke's solution, Carnoy's solution, Methacarn, Alcoholic formalin, Formol acetic alcohol or any combination thereof.

In some embodiments, the embedding material includes gelatin, acrylamide, or agarose gel.

In some embodiments, the embedding material is an agarose gel solution.

In some embodiments, the method further includes the step of slicing the specimen to a slice before the step (c).

In some embodiments, a thickness of the slice is about 100-1000 um.

In some embodiments, the method further includes the step of an antigen retrieval on the biological sample before the step (c).

In some embodiments, the specimen is immersed in the aforementioned cleaning composition for about 8-15 hours.

In some embodiments, the specimen is immersed in the aforementioned cleaning composition and applied with a centrifugal force for about 1-8 hours.

In some embodiments, the specimen is immersed in the aforementioned cleaning composition and placed within an electro field for about 1-8 hours.

In some embodiments, the mounting solution is the aforementioned cleaning composition.

In some embodiments, the method further includes a step of identifying an expression of the first or the second labeling material labeling on the specimen after the step (d) mounting, by a mounting solution, the permeated specimen on a slide.

### BRIEF DESCRIPTION OF THE DRAWINGS

One or more embodiments are illustrated by way of example, and not by limitation, in the figures of the accompanying drawings, wherein elements are having the same reference numeral designations represent like elements throughout. The drawings are not to scale, unless otherwise disclosed.

FIGS. 1A and 1B are schematic flow charts illustrating a difference of the staining procedure between the present disclosure and the prior art. The prior staining procedure (FIG. 1A) includes at least six necessary steps to prepare a transparent biological sample with at least two targets labeled. In addition, the present procedure (FIG. 1B) includes at least three necessary steps to prepare a transparent biological sample with at least two targets labeled.

FIG. 2 is a schematic bar chart illustrating a difference of the time consumption between the hematoxylin and eosin stain (H&E stain), the standard fluorescence stain and the clearing composition of the present disclosure.

FIGS. 3A to 3C are views illustrating a fresh human breast tissue specimen, which is collected from a female breast cancer patient and diagnosed with high Ki67 expression (20-70%) in pathological examination, treated with the clearing composition of the present disclosure for transparency and the images thereof captured by microscopy. More particularly, FIG. 3A is an image taken at a depth of 50 μm; FIG. 3B is an image taken at a depth of 100 μm; and FIG. 3C is an image taken at a depth of 150 μm.

FIGS. 4A and 4B are views comparing the images of a fresh human breast tissue specimen prepared by the method of the present disclosure and the prior art. FIGS. 4C and 4D are zoom-in views of the sections squared white in FIGS. 4A and 4B, respectively.

FIG. 5A are views comparing the images of a tissue specimen prepared by the clearing solution having different RI matching material. FIG. 5B and 5C are views illustrating a breast cancer tissue specimen which diagnosed with high Ki67 expression (20-70%) in pathological examination treated with the clearing composition having different surfactant and labeling material, and the images thereof captured by microscopy. More particularly, the RI matching material in the clearing composition used to treat with the tissue specimen in FIG. 5B is FocusClear™, and the RI matching material in the clearing composition used to treat with the tissue specimen in FIG. 5C is meglumine diatrizoate.

FIGS. 6A and 6B are views comparing the images of a tissue specimen prepared by the clearing solution having different CMC value of permeating material, and the images thereof captured by microscopy.

FIG. 7A 7B are views comparing the images of a tissue specimen prepared by the clearing solution having different solvent, and the images thereof captured by microscopy.

The drawings are only schematic and are non-limiting. In the drawings, the size of some of the elements may be exaggerated and not drawn on scale for illustrative purposes. The dimensions and the relative dimensions do not necessarily correspond to actual reductions to practice of the disclosure. Any reference signs in the claims shall not be construed as limiting the scope. Like reference symbols in the various drawings indicate like elements.

### DETAILED DESCRIPTION

The making and using of the embodiments of the disclosure are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Throughout the various views and illustrative embodiments, like reference numerals are used to designate like elements. Reference will now be made in detail to exemplary embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, an apparatus in accordance with the present disclosure. It is to be understood that elements not specifically shown or described may take various forms. Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. It should be appreciated that the following figures are not drawn to scale; rather, these figures are merely intended for illustration.

In the drawings, like reference numbers are used to designate like or similar elements throughout the various views, and illustrative embodiments of the present disclosure are shown and described. The figures are not necessarily drawn to scale, and in some instances the drawings have been exaggerated and/or simplified in places for illustrative purposes. One of ordinary skill in the art will appreciate the many possible applications and variations of the present disclosure based on the following illustrative embodiments of the present disclosure.

### DEFINITION

It will be understood that singular forms “a”, “an” and “the” are intended to include the plural forms as well, unless the context clearly indicates otherwise.

The term“about,” as used herein, when referring to a measurable value such as an amount, a temporal duration, and the like, is meant to encompass variations of ±10% and more preferably ±5% from the specified value, as such variations are appropriate to perform the disclosed methods.

As used herein, the terms “labeling material”, “dye”, “staining material” or “probe” are used interchangeably and refer to any material that is capable of targeting a specific molecule on a biological sample. It includes chemical compounds or biological compounds.

The term“depth,” as used herein, when referring to a measurable value such as an distance between the focal distance and the basal line of the sample.

As used herein, the terms “sample”, “clinical sample”, “specimen” or “biological sample” are used interchangeably and refer to any biological sample that may from a species other than human. It can be from any organism or any part of a body or tissue.

Unless otherwise defined, all terms (including technical and scientific terms) used herein have the same meaning as commonly understood by one of ordinary skill in the art to which this disclosure belongs. It will be further understood that terms; such as those defined in commonly used dictionaries, should be interpreted as having a meaning that is consistent with their meaning in the context of the relevant art and the present disclosure, and will not be interpreted in an idealized or overly formal sense unless expressly so defined herein.

The present disclosure teaches a clearing composition for rendering a biological material transparent. The clearing composition may also be referred to as “clearing solution”, “cleaning solution”, or “clearing composition”.

TABLE 1
Constituents of Clearing Composition.

| No. | Item | Example | Final Con. |
|---|---|---|---|
| 1 | RI matching | Radiocontrast agent, | 30 to 80% |
| | material | monosaccharide, | (W/V) |
| | | oligosaccharide, or any | |
| | | combination | |
| 2 | permeating agent | surfactant | 0.1 to 2% |
| | | | (V/V) |
| 3 | Solvent | PBS, DMSO, Glycerol, | N/A |
| | | ddH₂O or any | |
| | | combination | |
| 4-1 | first labeling | agonist, antagonist, antibody, | 100 ng/ml |
| | material | avidin, dextran, lipid | to 1 mg/mL |
| 4-2 | second labeling | nucleotide, or phallotoxin | |
| | material | | |
| 4-3 | third labeling | | |
| | material (optional) | | |

As illustrated above, the clearing composition of the present disclosure includes four major compositions, i.e., RI matching material, permeating agent, labeling materials, and solvent. The final pH value of the present clearing compositions needs to be in the range of 6.5˜8.4 to avoid the strong inhibition of the antibody-antigen reaction. Since the pH value of commercialized RI matching products (e.g., FocusClear™ and RapiClear®) are out of said range, the RI matching material needs to be limited for compositing with antibodies. The RI matching material includes radiocontrast agent, monosaccharide, oligosaccharide, or any combination thereof. The radiocontrast agent should be non-ionic to prevent the influence on the antibody-antigen reaction by sodium and chloride ions. Examples of radiocontrast, monosaccharide, and oligosaccharide are iodixanol, fructose, and sucrose, respectively. The effect of the RI matching material to the staining will be further illustrated in the following Example 3. The permeating agent has a major composition of surfactant. Typically, the critical micelle concentration (CMC) of permeation material for standard immunofluorescence thick tissue staining is within the range of 0.04 to 0.08. In comparison of standard thick tissue staining, the CMC of permeation material in this composition should within the range of 0.005 to 0.025, more preferably 0.01 to 0.015 to make the specimen permeable but keep the lipid of specimen for membrane staining. The following Embodiment 4 illustrates the effect of different CMC on membrane staining. With the stable nucleic staining, the membrane staining signal drop significantly with high CMC. Examples of surfactant include Triton X-100, Tween-20, Sodium dodecyl sulfate (SDS), n-Dodecyl-β-D-maltoside (DDM), Tween-80, Urea, 3-[(3-Cholamidopropyl) dimethylammonio]-1-propanesulfonate (CHAPS), sodium deoxycholate, or a combination thereof. Here, the preferable surfactant is Triton X-100, Tween-20 or the combination thereof. The solvent may include phosphate buffered saline (PBS), dimethyl sulfoxide (DMSO), glycerol, ddH₂O or any combination thereof.

Regarding the labeling material, the cleaning solution of the present disclosure includes at least two labeling materials for marking at least two molecules on a testing biological sample. The labeling material may be selected from agonist, antagonist, antibody, avidin, dextran, lipid nucleotide, or phallotoxin. Different kinds of labeling materials may be chosen for targeting different molecules, as the underlying test might require. For example, for labeling a nucleus, the preferred labeling materials are DAPI, Propidium Iodide, SYTO 16, SYTO 40, NucRed, or NucGreen. In another example, for observing cell morphology, the labeling material could be a lipophilic tracer fluorescence dye. It is worth to know that different labeling materials require different working concentration for achieving the adequate labeling result. In the present disclosure, a final working concentration of the labeling material is about 100 ng/ml to 1 mg/ml. More specifically, for marking a nucleus, the preferred final working concentration of the labeling material is about 100 ng/ml to 1 mg/ml. When labeling a molecule other than nucleus, the preferred final working concentration of the labeling material is about 1 μg/ml to 10 mg/ml.

The concentration or ratio of the RI matching material and permeating agent of the cleaning solution are critical to final image quality. RI matching material affects the transparency degree of the sample, and the permeating agent affects the labeling efficiency of labeling materials. Further, when excessive, permeating agent damages the testing biology sample or the labeling materials. On the other hand, when insufficient, permeating agent decreases the efficiency of the labeling materials targeting molecules on the testing biology sample. In the present disclosure, the preferred weight/volume percentage concentration of the RI matching material to the clearing solution is about 30 to 80% (w/v), and the preferred volume/volume percentage concentration of the permeating agent to the clearing solution is about 0.1 to 2% (v/v).

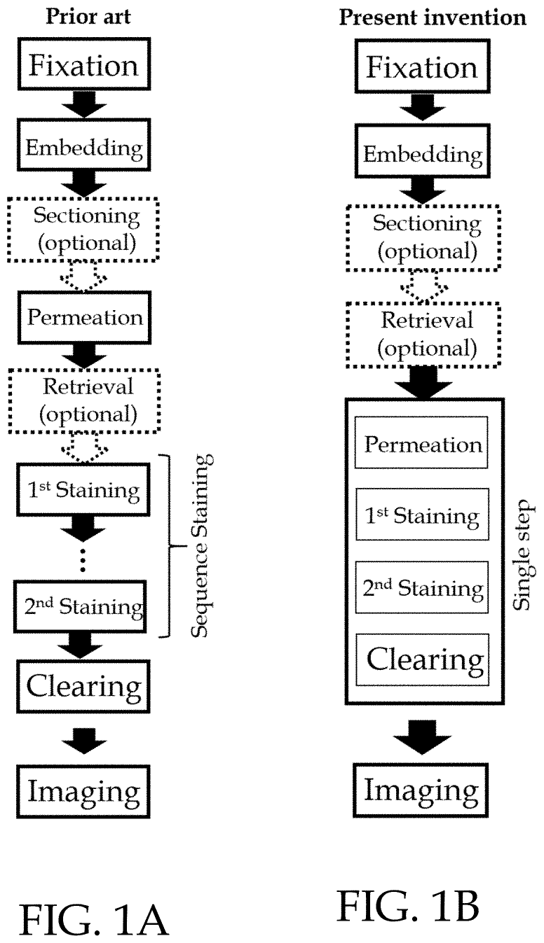

The present disclosure also discloses a kit for rendering a biological material transparent. The primary constituent of the kit is the cleaning composition. The kit may further include an anti-freezer, a humectant or both. FIGS. 1A and 1B disclose are schematic flow charts comparing different methods for clearing and staining a sample disclosed in the present disclosure and the prior art. Specifically, the process in FIG. 1A utilizes the clearing composition of the present disclosure, and the process in FIG. 1B utilizes conventional clearing solutions know in this field. As prior process (FIG. 1A) shows, when we want to prepare a transparent biological sample and further label at least two different targets with distinguished dyes, at least six steps are required. Specifically, said five necessary steps include: fixation, embedding, permeation, first staining, secondary straining, and clearing. The steps of permeation, first staining, secondary straining, and clearing are used to make the sample transparent and label the targets on the sample with different dyes. It is worth knowing that, when labeling multiple molecules/targets with different dyes through the conventional procedure/protocol, an extended amount of time is needed, depending on how many targets to be labeled. As process in FIG. 1A shows, in each staining reaction, only one single labeling material is incubated with the sample. As such, if multiple molecules/targets are to be labeled, such as two different proteins, on the sample, the time consumption required for the staining procedure then becomes twofold. The foregoing also causes the subsequent clearing procedure to require additional reaction time. Additionally, the total time of each round of staining procedure is affected by the staining materials used in the procedure. Some of the staining materials, such as chemical synthetic dye or fluoresce conjugated probe, are capable of binding to the target directly, and thus is less time-consuming comparing to the staining procedures using antibodies. The chemical synthetic dye or fluoresce conjugated probe may include agonist, antagonist, antibody, avidin, dextran, lipid nucleotide or phallotoxin. It is well known by a person having ordinary skill in the art that using antibodies to label targets takes more time than using chemical synthetic dyes or fluoresce conjugated probes. The reason causing the foregoing is that the antibody staining procedure is a sandwich labeling method. A primary antibody is used in a first round reaction to label a target/molecule, then the secondary antibody conjugated with a fluorescence material is used to connect to the primary antibodies so it becomes detectable under a microscopy. To quickly sum, conventional procedures for labeling multiple targets and making the sample transparent is time consuming and is not ideal for medical institutions, such as hospitals. The present disclosure provides a clearing composition and a method such that medical institutions may generate a transparent sample with labeling targets within a shortened amount of time. As a result, doctors are more able to discern the medical conditions of the target and provide patients advice and treatments in a more timely manner.

The process in FIG. 1B discloses a high-through-put staining procedure of the present disclosure. In the present staining procedure, the steps of permeation, staining(s) and clearing are merged in a single step. In other words, in our disclosure, the permeation, staining(s) and clearing are conducted concurrently in one step. Therefore, comparing processes in FIG. 1A and 1B, the clearing composition and the method of the present disclosure for staining targets on a biological sample and making it transparent is much more efficient than those in the prior art. Moreover, desired results, i.e., quality of image and the eventual diagnosis evaluation, can still be acquired.

TABLE 2
Time Consumption of different staining procedure

| | | Staining Type | | |
|---|---|---|---|---|
| | | | Standard | |
| | | | fluorescence | Present |
| | Procedure | H&E Stain | Stain | Disclosure |
| Time | Fixation | >6 | >6 | >6 |
| (Hours) | | | | |
| | Preparation | 17 | 54-72 | 8-15 |
| | Imaging | 0.1 | 2 | 2 |
| | Total | 23.1 | 62-80 | 16-23 |

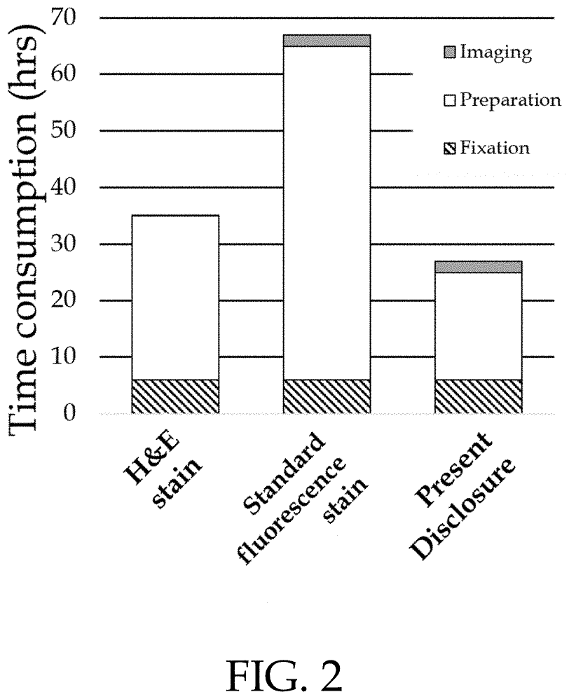

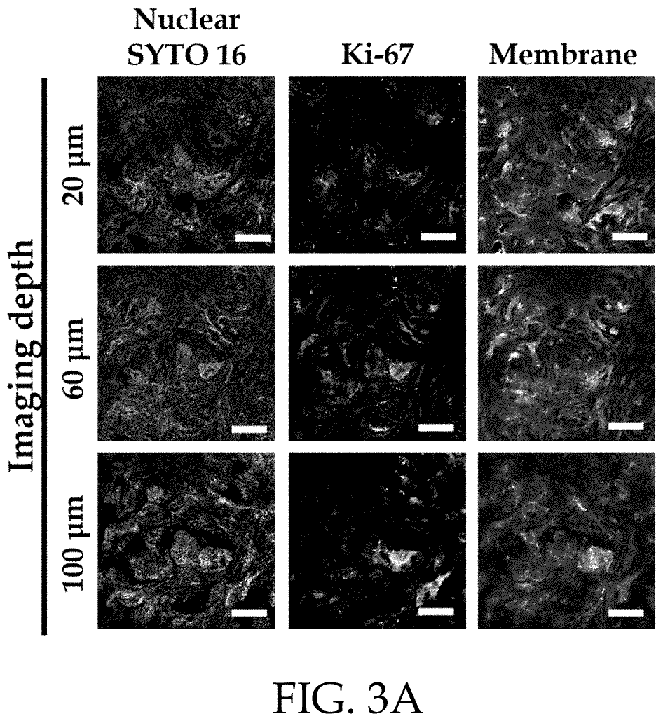

FIG. 2 is a schematic bar chart illustrating the difference in time consumption between the H&E stain, the standard fluorescence stain, and the present disclosure. Table 2 is a statistical data of FIG. 2. FIG. 2 and Table 2 also show the time required for different procedures (i.e., fixation, preparation, and imaging) in the three types of staining procedure. Attention is directed to Table 1, where the entire duration of staining process of the present disclosure is less than that of the H&E stain or the standard fluorescence stain. Particularly, the present method needs less than fifty percent of the total time required for the standard fluorescence stain. More specifically, the time required for fixation in the three staining procedures is very similar. Even though the imaging step in the present disclosure appears to take more time than that in the H&E stain, it is offset by the preparation time. In sum, based on the present disclosure, the total amount of time needed for staining is reduced. Moreover, the eventual microscopy analysis result is optimized because the tissues are better preserved due to the shortened preparation time.

Taken together, utilizing the present disclosure, a pathology department of a hospital could more effectively render multiple targets on a clinical sample and make it transparent for further microscopy analysis. Therefore, a doctor could identify the expression profiles of specific molecules on a clinical sample (e.g., a patient sample) more clearly, within a shortened amount of time and the single-step preparation process also reduce the manual operation cost. It also facilitates the doctor to diagnose a possible symptom or disease and provide treatment plans to the patient more effectively and efficiently.

### EXAMPLES

The human clinical sample used in the following examples is a female breast tissue diagnosed with high Ki67 expression (20-70%) in pathological examination. In other words, the human clinical sample is a Ki67 positive control sample.

### Example 1. Rendering a Clinical Tissue With the Cleaning Solution of the Present Disclosure and Detecting its Morphology by Microscopy Assay

To evaluate the effect of the present disclosure, we use the present cleaning solution to render a human clinical sample (here, a female breast tissue diagnosed with high Ki67 expression (20-70%) in pathological examination) and further exam the staining efficiency through microscopy assay. The following Tables 3-1 and 3-2 discloses the details of the compositions of the cleaning solution used in the experiment.

TABLE 3-1
The detailed composition of the cleaning solution

| | | | | Final | |
|---|---|---|---|---|---|
| No. | Item | Description | Brand (Cat.) | Concentration | |
| 1 | RI matching material | Sucrose | Amresco (0335) | 58% | w/v |
| 2 | permeating agent | Triton X-100 | J. T. Baker (JT-X198-07) | 0.5% | v/v |
| 3 | first labeling material | SYTO 16 | ThermoFisher (S7578) | 5 | μM |
| 4 | second labeling material | DiD | ThermoFisher (D307) | 20 | μg/ml |
| 5 | third labeling material | Anti-Ki67 conjugated | abcam (ab215226) | 0.5% | v/v |
| | | with AlexaFluor ® 555 | | | |

| | | | | |
|---|---|---|---|---|
| 6 | Solvent | PBS | Protech (BF-203) | N/A |

TABLE 3-2

| | | | | Final | |
|---|---|---|---|---|---|
| No. | Item | Description | Brand (Cat.) | Concentration | |
| 1 | RI matching material | Sucrose | Amresco (0335) | 58% | w/v |
| 2 | permeating agent | Triton X-100 | J. T. Baker (JT-X198-07) | 0.5% | v/v |
| 3 | first labeling material | SYTO 16 | ThermoFisher (S7578) | 5 | μM |
| 4 | second labeling material | Anti-CD8 conjugated | abcam (ab204015) | 0.5% | v/v |
| | | with AlexaFluor ® 647 | | | |

| | | | | |
|---|---|---|---|---|
| 6 | Solvent | PBS | Protech (BF-203) | N/A |

The present disclosure also discloses a high-throughput staining method using the cleaning solution herein. The basic steps of the staining method are: 1) fixing the specimen, 2) embedding the specimen, 3) immersing the specimen in the cleaning solution and 4) imaging the processed specimen.

For step one, a fresh breast tissue specimen was collected from a female patient with indication of breast cancer. The tissue specimen was rinsed with PBS for 10 minutes, and then soaked up with a paper to decrease moisture. Further, the tissue specimen was fixed in 4% formaldehyde for later use. For step two, the fixed tissue specimen was embedded in a 3% (w/v) agarose gel solution at room temperature for 10 minutes and further at 4° C. for another 10 minutes. The fixed tissue specimen was sectioned into slices with a thickness of about 100 to 150 μm. For step three, the tissue specimen slice was immersed into and permeated by the clearing solution for staining cell nucleus and membrane on the tissue specimen and making it transparent. Further, this step was carried out at 25° C. for 12 hours. The detailed composition of the cleaning solution is listed in Tables 3-1 and 3-2. Particularly, SYTO 16 was used to label cell nucleus, and 1,1′-Dioctadecyl-3,3,3',3′-Tetramethylindodicarbocyanine Perchlorate (DiD) was used to label cell membrane. For step four, the transparent and labeled tissue specimen, with a thickness of about 150 μm, was imaged from the top surface to the bottom surface with an LSCM system (LSM780; Zeiss) to obtain about a hundred successive 2D images of the specimen, which were then used to generate a 3D composite image of the specimen. These images were acquired by excitation and emission at 480 nm and 525 nm, respectively, for detection of SYTO 16; and at 638 nm and 700 nm for detection of DiD. The lateral resolution (in the x and y directions) was less than 1 μm and the axial resolution (in the z direction) was less than 2 μm.

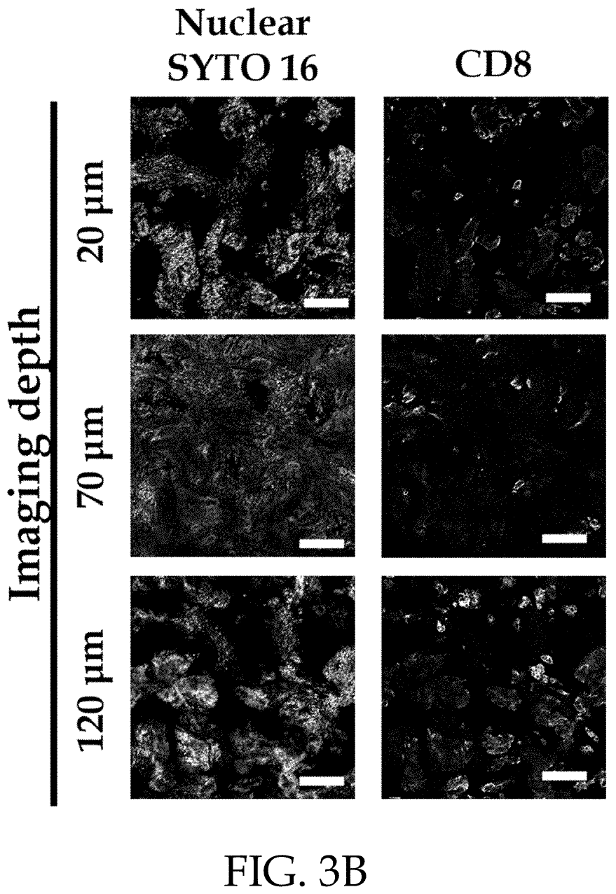

FIGS. 3A and 3B are images taken from the transparent and labeled tissue specimen prepared by the aforementioned high-through-put staining method of the present disclosure. The scale bar in FIG. 3A represents 100 μm. Further, the images in FIG. 3A are taken at the depth of 20 μm, of 60 μm and of 100 μm, respectively. It is evident from the images that the tissue morphology is very clear in all three different layers, and the labeling pattern of SYTO 16 and DiD is very even. In other words, the present clearing solution and the utilization method thereof are capable of labeling a biology sample and making it transparent for further image analysis more efficiently and effectively. Additionally, the images in FIG. 3B are taken at the depth of 20 μm, of 70 μm and of 120 μm, respectively. The scale bar in FIG. 3B represents 200 μm. It is worth to know that the staining material used in FIG. 3B is an anti-CD8 antibody. Moreover, the antibody staining result in FIG. 3B also displays the similar result as FIG. 3A.

### Example 2. Comparing Efficiency and Labeling Effect of the Present Disclosure With Those of Standard Fluorescence Staining

To further distinguish the advantage of the present disclosure from standard fluorescence staining, we used the same clinical specimen as in Example 1 with two different staining procedures. Further evaluation was conducted to discern the respective efficiency and labeling effect through microscopy analysis.

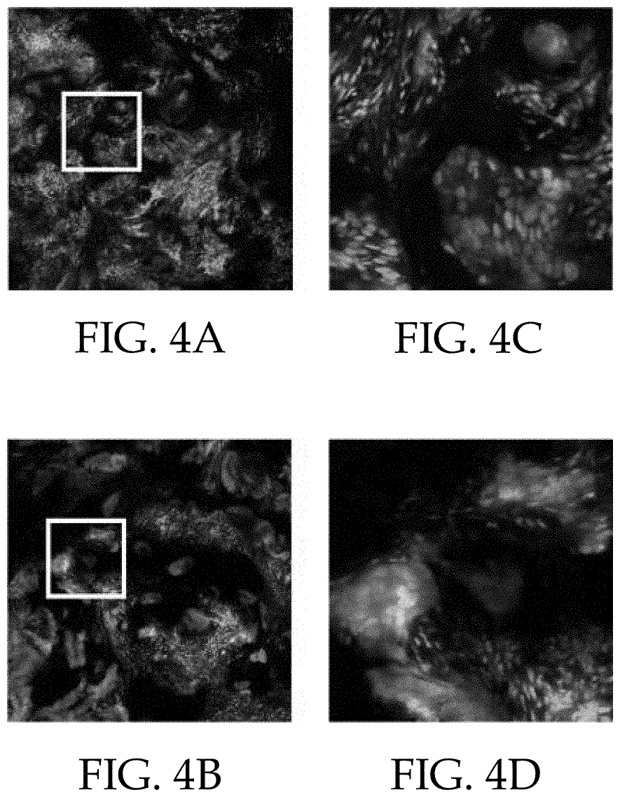

FIGS. 4A and 4C are images taken from the clinical specimen processed by the method of Example 1, and FIGS. 4B and 4D are those processed by standard fluorescence staining. Images in FIGS. 4A to 4D are taken at 100 μm depth. Moreover, FIGS. 4C and 4D are zoom-in image of the area squared white in FIGS. 4A and 4C, respectively.

Attention is directed to FIGS. 4A and 4B, the labeling effect (e.g., staining quality) may seem similar. However, when detailed comparison is made between the images in FIGS. 4C and 4D, the resolution and image quality of FIG. 4C is much higher than FIG. 4D. In other words, the present high-through-put staining method with the present clearing solution is capable of rendering the specimen transparent more effectively so as to provide doctors a better or more accurate molecule expression profile for particular diagnosis purposes. Furthermore, the total reaction time of the present clearing and staining procedure is about 54 hours, which is much less than the total reaction time of standard fluorescence staining, which ordinarily takes about 23 hours. Taken together, the advantages of the present disclosure compared with the prior art at least are: 1) more accurate molecule expression profile of the clinical specimen, 2) less time consumption, and 3) less cost due to the simplified procedures/reduced number of steps.

### Example 3. pH Value and Ionic Material of the Clearing Composition Affect the Labeling Ability of the Staining Materials

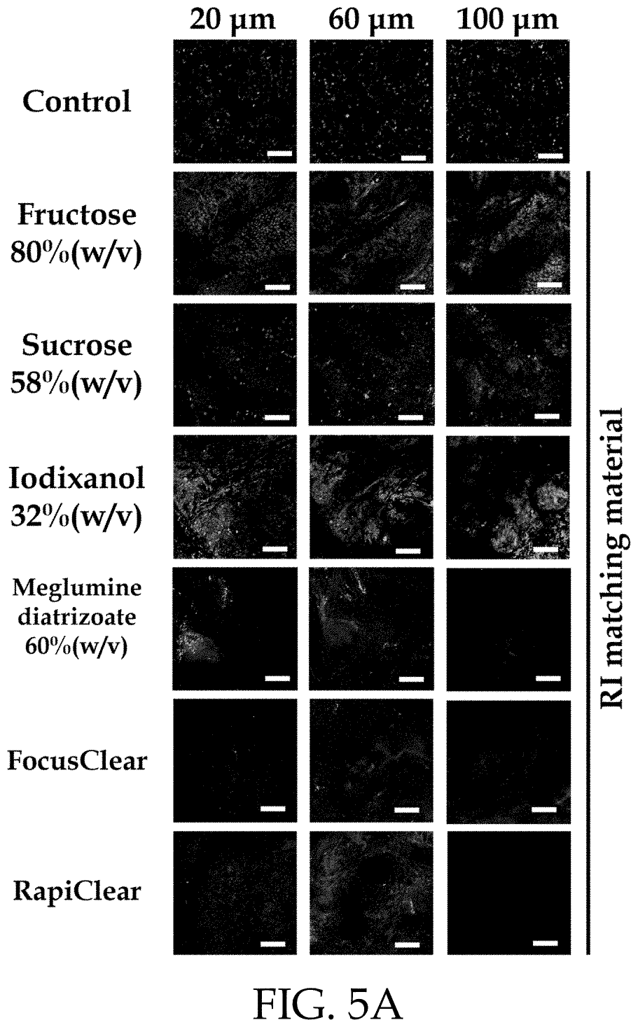

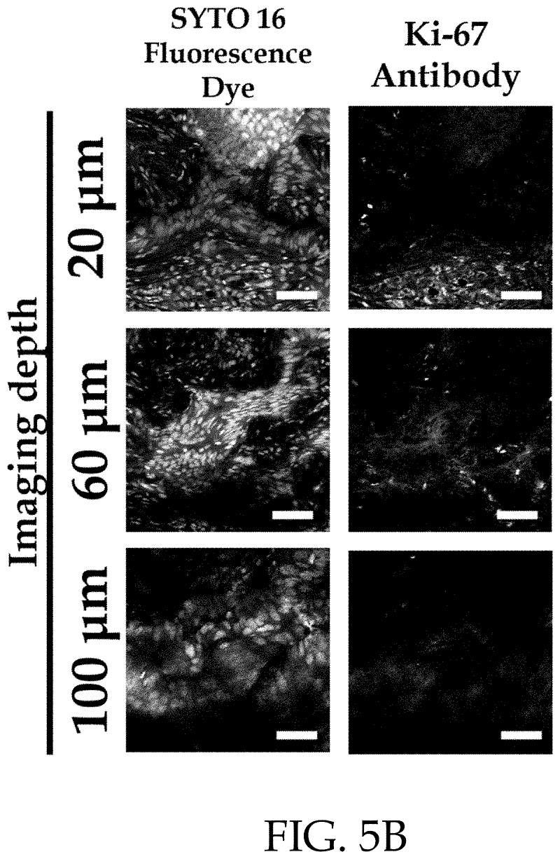

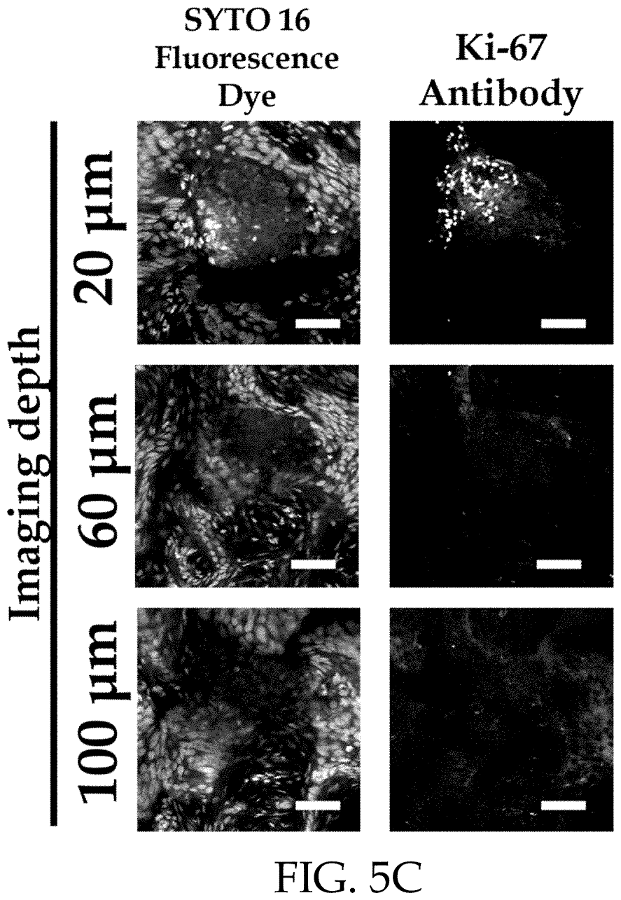

FIG. 5A discloses a ki67 expression profile on a breast cancer specimen diagnosed with high Ki67 expression (20-70%) in pathological examination. Specifically, the breast cancer tissue specimens were treated with the clearing composition contains an anti-ki67 antibody conjugated with AlexaFluor® 555 (abcam, ab215226) and different RI matching materials as following Table 4. The general rendering procedure is as same as the previous embodiment shows. The scale bar in each image is about 50 μm. Additionally, the control group in the first row follows the standard immunofluorescence staining process with FocusClear™ clearing.

As the results disclose, the final pH value of the clearing composition and ionic material in the clearing composition significantly affect the staining performance. Specifically, the RI matching material with appropriate pH and without non-ionic material help antibodies (e.g., clearing composition) maintain the binding affinity. As the results disclose, the groups using prior RI matching materials (e.g., FocusClear™ and RapiClear®) show poor staining effect. It is worth to know that the pH value of FocusClear™ and RapiClear® are about 10 to 11. Moreover, the groups using the RI matching material without ionic material (e.g., the Fructose, Sucrose, and Iodixanol groups) also show good staining performance. It is worth to know that even though the pH value of the Meglumine diatrizoate group is within 6 to 8, its staining result is still extremely poor. Taken together, when using the clearing composition with antibodies to stain the tissue specimen, the preferable condition is: 1) pH values is about 6.5 to 8.4, and 2) the clearing composition does not include any ionic material.

According to the previous mention, the extreme pH condition results antibodies conformational change and damages the complementarity with the antigen. To further demonstrate that the prior RI matching material decreases the antibody staining effect due to its pH value, we perform the similar experiment as FIG. 5A. The breast cancer tissue specimens were treated with FocusClear™ having different staining materials (e.g., nucleic acid SYTO 16 (Thermo Fisher Scientific, S7578) or anti-ki67 antibody conjugated with AlexaFluor® 555 (abcam, ab215226). As FIG. 5B discloses, the expression profile of the fluorescence dye SYTO 16 is very significant in different depth of layers (e.g., 20, 60, or 100 μm). However, the staining result of using antibody (e.g., anti-ki67) is not as expected. The fluorescence signal and the staining specificity of the anti-Ki67 both decrease through the depth, and it does not perform as nuclear specific staining. Therefore, according to the result, FocusClear™ only damages the protein-based labeling material such as antibodies.

In order to confirm previous description that pH condition and ionic material both significantly affect the antibody staining ability. The same breast cancer tissue specimens were treated with a clearing solution, wherein the RI matching material is meglumine diatrizoate (60% w/v) and the staining materials are the nucleic acid SYTO 16 (Thermo Fisher Scientific, S7578) and anti-ki67 antibody conjugated with AlexaFluor® 555 (abcam, ab215226). As FIG. 5C discloses, the result is similar with FIG. 5B, the expression profile of the fluorescence dye SYTO 16 is very significant in different depth of layers (e.g., 20, 60, or 100 μm), but the staining result of using antibody (e.g., anti-ki67) is not as expected.

TABLE 4

| | | | | Meglu- | | |
|---|---|---|---|---|---|---|
| | Fruc- | Su- | | mine dia- | | |
| | tose | crose | Iodixanol | trizoate | FocusClear | RapiClear |
| Con. | 80% | 58% | 32% | 60% | 100% | 100% |
| %(w/v) | | | | | | |
| pH | 6.57 | 7.03 | 7.4 | 7.29 | 10.9 | 9.94 |
| Ionic | None | None | None | Yes | Yes | Yes |
| material | | | | | | |

### Example 4. The Membrane Staining Effect of Different Critical Micelle Concentration (CMC) Value of Permeation Material

As previous mention, with the stable nucleic staining, the membrane staining signal drop significantly with high CMC. Further, the preferable surfactant in the present disclosure includes Triton X-100 or Tween-20.

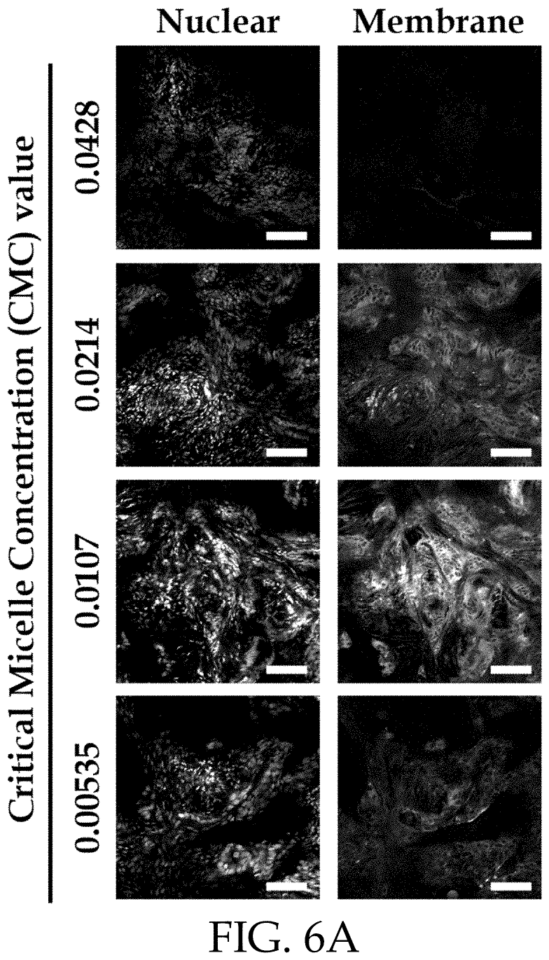

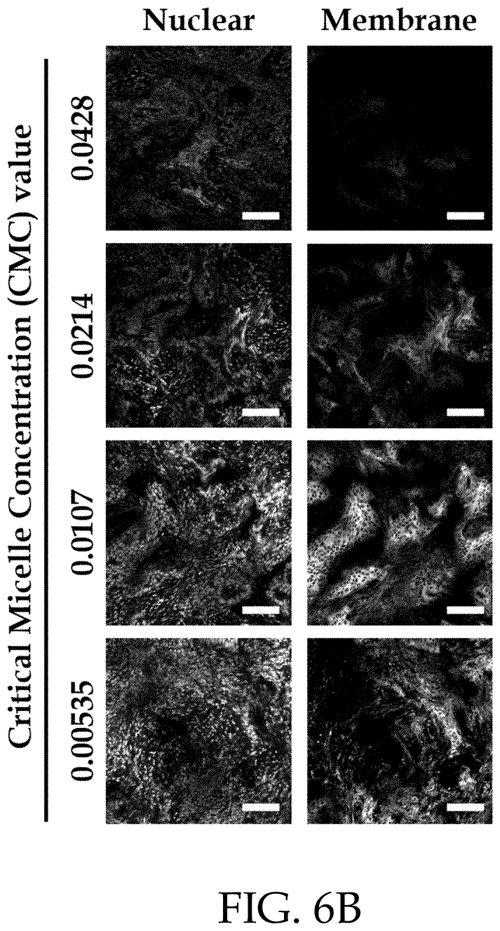

FIGS. 6A and 6B further illustrate the CMC value is critical to the rendering of the staining material. Briefly, a breast cancer specimen was treated with the present clearing composition following with the present procedure as previous embodiment disclosed. However, it is worth to know that the surfactant used in the clearing composition is Triton X-100 (FIG. 6A) or Tween-20 (FIG. 6B), and the labeling material is SYTO 16(nuclear) and DiD(membrane). Further, in order to evaluate what is the preferable CMC value, we performed the staining with the different CMC of the Triton X-100 (FIG. 6A) or Tween-20 (FIG. 6B) to identify the staining performance.

As the results in FIG. 6A and 6B show, the CMC value indeed affects the labeling material binding on the membrane. More specifically, when the CMC value of the surfactant is too high (e.g., 0.0428), the surfactant digests lipids and reduces the labelling performance (the first-row images). On the contrary, when the CMC value of the surfactant is too low (e.g., 0.00535), the surfactant could not provide effective permeation and result weak labelling performance (the fourth-row images). Therefore, only using a certain range of CMC value of the surfactant in the present clearing solution results in a preferable and accurate staining result. More specifically, the CMC value of permeation material in the present clearing solution is about 0.005 to 0.025, more preferably 0.01 to 0.015, to make the specimen permeable but keep the lipid of specimen for membrane staining.

### Example 5. The Organic Solvent and Deoxidant Also Affect the Staining Ability of Antibodies

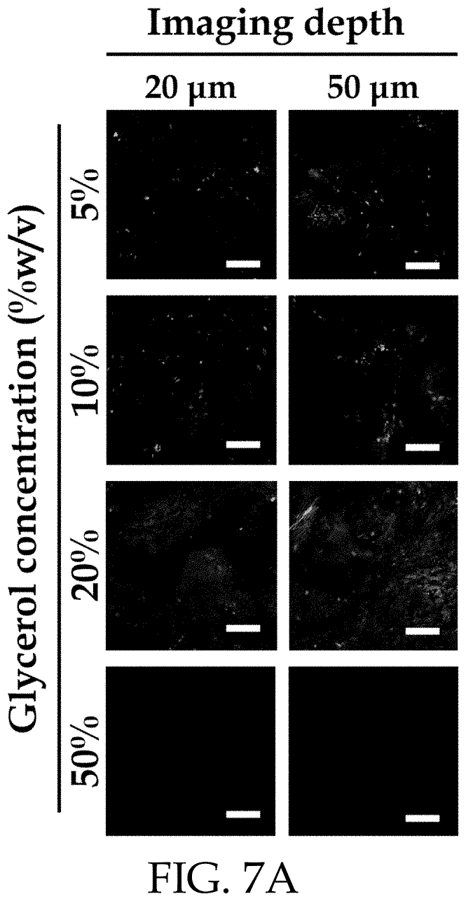

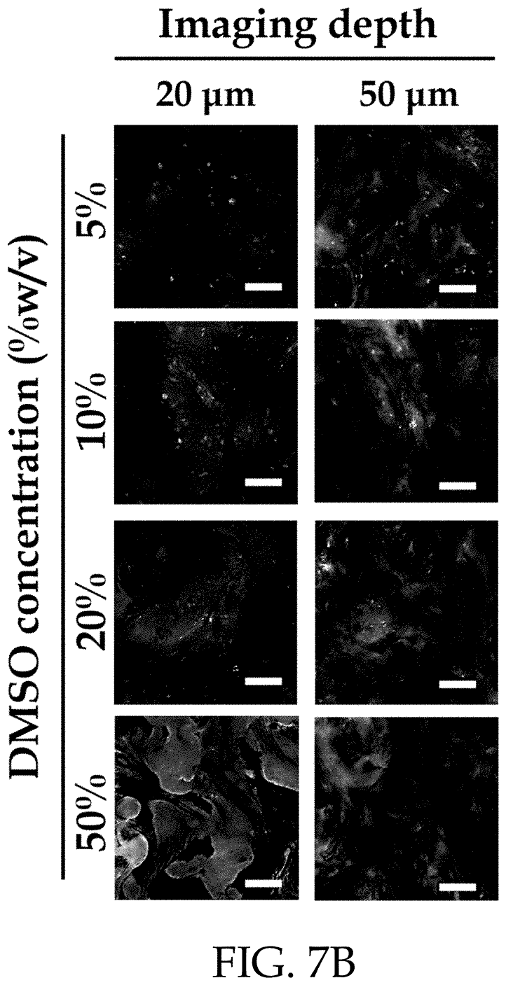

DMSO and glycerol are the common materials of solvent combination in tissue clearing composition because of the anti-freezing function. However, DMSO is an organic solvent, and it denatures a protein when it is in high concentration. Additionally, glycerol is a deoxidant that also affects the antibody binding reaction. FIGS. 7A and 7B illustrate the results that support the above description. FIG. 7A is a view comparing the images of a tissue specimen prepared by the clearing solution, wherein the solvent is glycerol. FIG. 7A discloses that there is no fluorescence signal on the specimen, no matter in which depth of the layer, when using high concentration of glycerol as a solvent. In other words, high concentration (50% w/v) of glycerol inhibits the binding between the anti-Ki67 antibody and antigen. However, the anti-Ki67 antibody effectively binds to the target on the specimen when the concentration of the glycerol is between about 5 to 20% (w/v).

FIG. 7B is a view comparing the images of a tissue specimen prepared by the clearing solution, wherein the solvent is DMSO. The result in FIG. 7B shows that the anti-Ki67 antibody binding specificity decreases along with increasing the DMSO concentration. Specifically, when using high concentration (50% w/v) of DMSO as a solvent in the present clearing solution, the anti-Ki67 antibody is no longer nuclear-specific binding. However, the anti-Ki67 antibody effectively binds to the target on the specimen when the concentration of the DMSO is between about 5 to 20% (w/v).

Therefore, according to the results of FIG. 7A and 7B, the concentration of DMSO and glycerol should less be than 20% (v/v) when using these two materials as a solvent in the present clearing composition.

### Example 6. Rendering a Clinical Tissue With the Cleaning Solution of the Present Disclosure With Adding Centrifugal Force and Detecting its Morphology by Microscopy Assay

According to the previous mention, using the present clearing solution could efficiently reduce the total time of an analysis. Further, some of studies disclose that using additional force also improves the staining performance and reduces the time of staining. (Lee, Eunsoo, and Woong Sun. “ACT-PRESTO: Biological tissue clearing and immunolabeling methods for volume imaging.” JoVE (Journal of Visualized Experiments) 118 (2016): e54904.) It is worth to know that said technology also could be applied into the present method to further reduce the total analysis time.

1. A clearing composition for rendering a biological material transparent, comprising:
a Refractive Index (RI) matching material, comprising radiocontrast agent, monosaccharide, oligosaccharide, or any combination thereof;
a permeating agent including a surfactant;
a first labeling material;
a second labeling material; and
a solvent;
wherein the first and second labeling material is selected from the group consisting of agonist, antagonist, antibody, avidin, dextran, lipid nucleotide and phallotoxin;
wherein pH value of the biological material transparent is about 6.5 to 8.4.

2. (canceled) The clearing composition of claim 1, wherein pH value of the biological material transparent is about 6.5 to 8.4.

3. (canceled) The clearing composition of claim 1, wherein the RI matching material comprises radiocontrast agent, monosaccharide, oligosaccharide, or any combination thereof.

4. The clearing composition of claim 1, wherein the RI matching material comprises iodixanol, fructose, sucrose, or any combination thereof.

5. The clearing composition of claim 1, wherein the permeating agent comprises a detergent.

6. The clearing composition of claim 1, wherein the surfactant does not have any ionic material.

7. The clearing composition of claim 1, wherein the surfactant comprises Triton X-100, Tween-20, Tween-80, Sodium dodecyl sulfate (SDS), n-Dodecyl-β-D-maltoside (DDM), Urea, 3-[(3-Cholamidopropyl) dimethylammonio]-1-propanesulfonate (CHAPS), sodium deoxycholate, or any combination thereof.

8. The clearing composition of claim 1, wherein the surfactant is selected from the group consisting of Triton X-100 and Tween 20.

9. The clearing composition of claim 1, wherein a critical micelle concentration (CMC) value of the surfactant is about 0.01 to 0.025.

10. The clearing composition of claim 1, wherein the solvent comprises phosphate buffered saline (PBS), ddH₂O, or any combination thereof.

11. (canceled) The clearing composition of claim 1, wherein the first and second labeling material is selected from the group consisting of agonist, antagonist, antibody, avidin, dextran, lipid nucleotide and phallotoxin.

12. The clearing composition of claim 1, wherein the first labeling material comprises DAFT, Propidium Iodide, SYTO 16, SYTO 40, NucRed or NucGreen.

13. The clearing composition of claim 1, wherein the second labeling dye comprises a lipophilic tracers fluorescence dye.

14. The clearing composition of claim 1, wherein a weight/volume percentage concentration of the RI matching material to the clearing composition is about 30-80% (w/v).

15. The clearing composition of claim 1, wherein a volume/volume percentage concentration of the permeating agent to the clearing composition is about 0.1-2% (v/v).

16. The clearing composition of claim 1, wherein a concentration of the first labeling material to the clearing composition is about 100 ng/ml to 1 mg/ml.

17. The clearing composition of claim 1, wherein a concentration of the second labeling material to the clearing composition is about 1 ug/ml to 1 mg/ml.

18. The clearing composition of claim 1, wherein a volume/volume percentage concentration of the solvent to the clearing composition solvent is less than 20% (v/v).

19. The clearing composition of claim 1, further comprising a third labeling material.

20. A kit for rendering a biological material transparent, comprising the clearing composition of claim 1.

21. The kit of claim 17, further comprising an anti-freezer, a humectant or combination thereof.

22. A method for making a biological material transparent and further labeling the biological material, comprising:
(a) fixing a specimen with a fixative solution;
(b) embedding the specimen into an embedding material;
(c) immersing an embedded specimen in the clearing composition of claim 1 to allow the clearing composition to permeate the embedded specimen; and
(d) mounting, by a mounting solution, the permeated specimen.

23. The method of claim 19, wherein the fixation reagent comprises formaldehyde, phosphate buffered formalin, formal calcium, formal saline, zinc formalin, Zenker's fixative, Helly's fixative, B-5 fixative, Bouin's solution, Hollande's, Gendre's solution, Clarke's solution, Carnoy's solution, Methacarn, Alcoholic formalin, Formol acetic alcohol, or any combination thereof.

24. The method of claim 19, wherein the embedding material comprises gelatin, acrylamide, or agarose gel.

25. The method of claim 19, wherein the embedding material is an agarose gel solution.

26. The method of claim 19, further comprising slicing the biological sample to a slice before the step (c).

27. The method of claim 23, wherein a thickness of the slice is about 100-1000 um.

28. The method of claim 19, further comprising an antigen retrieval on the biological sample before the step (c).

29. (canceled) The method of claim 22, further comprising immersing on the biological sample into a blocking buffer before the step (c).

30. The method of claim 19, wherein the biological sample is immersed in the cleaning composition of the kit of claim 1 for about 8-15 hours.

31. The method of claim 19, wherein the biological sample is immersed in the clearing composition and applied with a centrifugal force for about 1-8 hours.

32. The method of claim 19, wherein the biological sample is immersed in the clearing composition and placed within an electro field for about 1-8 hours.

33. The method of claim 19, wherein the mounting solution comprises the clearing composition of claim 1.

34. The method of claim 19, further comprising a step of identifying an expression of the first or the second labeling material labeled on the specimen after the step (d).
